(19) United States
(12) Patent Application Publication
(10) Pub. No.: US 2020/0345467 A1
(43) Pub. Date: Nov. 5, 2020

(54) FASTENING ELEMENT AND SYSTEM FOR INTRODUCTION IN THE TOOTH CANAL AND USE OF THE FASTENING ELEMENT FOR INTRODUCTION IN THE TOOTH CANAL

(71) Applicant: ANGELUS INDUSTRIA DE PRODUTOS ODONTOLOGICOS S/A, Londrina - PR (BR)

(72) Inventor: Roberto Queiróz Martins ALCÂNTARA, Londrina - PR (BR)

(21) Appl. No.: 16/964,705

(22) PCT Filed: Aug. 17, 2018
(86) PCT No.: PCT/BR2018/050292

§ 371 Date: Jul. 24, 2020

(30) Foreign Application Priority Data
Jan. 25, 2018 (BR) 102018001658-0

(51) Int. Cl. A61C 13/30; A61C 5/35; C08J 5/04

(52) U.S. Cl. CPC A61C 13/30; A61C 5/35; C08J 2363/00; C08J 5/044; A61C 2201/005; C08J 5/043

(57) ABSTRACT

Fastening element and system for introduction in the canals of teeth to be treated, being used alone or together with a prefabricated intra-radicular pin serving as a root reinforcement or an anchorage of prostheses to be installed on the tooth, said fastening element comprises:—a body of parallel or conical shape;—a parallel or tapered longitudinal through bore; and—a main longitudinal slot running from the upper end to the lower end of the body of the fastening element.

### FIELD OF THE INVENTION

The present invention relates to the field of odontology. More precisely, the present invention relates to a fastening element and system for introduction in teeth canals to be treated being used alone or together with a prefabricated intra-radicular pin serving as a root and/or anchor reinforcement of prostheses to be installed on the tooth.

### BACKGROUND OF THE INVENTION

Pins used in teeth after canal treatment for root and/or anchor reinforcement of prostheses to be installed on the teeth are normally produced by two methods.

The first method being directly on the root, where the dentist uses a resin to produce a pin that copies the entire shape and internal diameter of the canal (individualized), the pin obtained by the dentist is sent to the laboratory to be fused in metal by the lost wax casting process.

FIG. 1A shows the introduction of a plastic pin of the prior art. In FIG. 1B is demonstrated a filling of the canal with resin. In FIG. 1C is observed the filling of the upper part of the canal with resin and in FIG. 1D the final shape after the sculpture with the use of drills is provided. The final part of FIG. 1D is removed from the tooth and sent to the laboratory that melts the plastic into a metal part.

The second method is the use or prefabricated pins in metal, glass or carbon fibers, as shown in FIG. 2.

Prefabricated pins in glass or carbon fibers have the advantage of not being subjected to corrosion like the metallic ones, thus, not leading to their early loss, besides not causing metallic taste in the patient's mouth. In addition, the prefabricated pins have a modulus of elasticity (flexibility) of 18 GPa, similar to that of the dentin in the crown's portion, which is about 20 GPa and in the root's portion, which is 9 to 10 GPa. This flexibility of the pins in fibers minimizes root fracture risks where they are installed, because in the case of an excessive force they undergo a flexion absorbing the shocks not transferring to the dental root.

In cases of excessive force on the metal pins, because they do not undergo flexion as the fiber pins transfer them to the tooth causing fractures in the roots and, therefore, loss of the dental element.

In addition, prefabricated pins can be manufactured in the white color, allowing the professional to make prostheses more aesthetic, therefore, more accepted by the patient.

However, while said pins are prefabricated with diameters close to those of the canals prepared to receive them, they have the disadvantage of not being perfectly adapted to any size and diameter of the canal. As a result of this partial adaptation, the prefabricated pins in glass or carbon fibers lose part of their retentive capacity, being able to move from the root after their cementation in the canal. This displacement can cause loss of the prosthesis performed on this pin by the dentist.

In this sense, several proposals were submitted with the intention of solving the lack of a good adaptation of the prefabricated pins to the canal of the tooth causing low mechanical overlapping and, therefore, low retentivity of the prefabricated pins.

European patent EP 1 925 269, in the name of HARALD E. NORDIN and Peter NORDIN, and entitled “Tooth root canal anchorage assembly” reports a hollow structure to be positioned above the root, i.e., on the prefabricated pin already installed, and thus has the sole function of providing a supra-structure on the prefabricated pin to support the suture prosthesis.

European patent EP 1 925 269 differs from the present invention, whose fastening element is installed together with the pin internally of the canal, since, it is intended to provide greater retentivity thereto within the canals.

U.S. Pat. No. 5,816,816 in the name of JONATHAN SCHARF and entitled “Method of producing fiber reinforced dental post and resulting dental post” reports a process for making a pin to be installed in the tooth canal, aiming at supporting the future prosthesis to be installed on the same. It uses a braided fiber rope closed in its lower portion that should receive a hollow mandrel and, in the sequence, positioned inside the canal. Thereafter, a needle is adapted into the hollow mandrel and resin is injected at the same time as the mandrel is removed from the canal. The hollow rope set now filled with resin is transformed in a pin to support the future prosthesis.

Although the system of U.S. Pat. No. 5,816,816 has a rope-shaped hollow fastening element to be filled by resin, it has no similarity with the present invention, the purpose of which is to provide a higher retentivity of a pin to be installed together with the same. It is important to note that the pin obtained by U.S. Pat. No. 5,816,816 will behave only as a conventional pin already known from the prior art, differing only in the manufacturing process.

European patent EP 0809475, in the name of REYNAUD MARC and REYNAUD PIERRE LUC, entitled “Self-locking Dental Post” reports a process for obtaining a pin to be positioned within the canal to support the future prosthesis to be positioned over the same. The process of said patent comprises a rigid element in its central part and an uncured material on the outside that, when positioned inside the canal, molds to the walls thereof, and is then cured to remain fixed within the canal. The final result of this process will be a conventional pin differing from the state of the art only by the manufacturing process.

The present invention differs from the European patent EP 0809475 in that it contains elements that, when installed with the conventional pins available, will prompt its mechanical overlapping within the canal by providing it with retentivity in canals of the various diameters where it will be installed.

European patent EP 0576510, published on Jan. 5, 1994, in the name of LARS HANSSON, and, entitled: “A root canal pin” reports a pin to be installed in the tooth canal containing a longitudinal and central slit being opened in the bottom of the pin to be fitted at the end of the root and a column at its top part to facilitate support of the future prosthesis. While the pin of said patent has a slot similar to the present invention, the function of which is to be closed causing greater retention of the pin at its end portion, the pin thereof does not contain all of the elements and features in accordance with the present invention.

U.S. Pat. No. 4,622,012 published on Nov. 11, 1986 in the name of LEWIS S. SMOLER, entitled: “Dental post system” reports a two-pins system to support the future prosthesis. The first pin of tubular shape is positioned in the canal to receive a resinous material injected in its interior with function of filling this tube and cementing the same. Then, a second pin is inserted therethrough in its tubular portion, forcing the excess cement to return to the top part of the same. Unlike the present invention, although it contains tubular elements, the system of U.S. Pat. No. 4,622,012 has as sole function of receiving the cement, forcing it against the walls of the canal and providing a good distribution of the same, ensuring a good adhesion of the same to the canal, but it does not contain all the elements and features of the present invention.

U.S. Pat. No. 5,326,263 published on Jul. 5, 1994 in the name of BERNARD WEISSMAN, entitled “Light-curable tooth reinforcement” reports the introduction of a flexible pin into the canal which will then be filled with an uncured resin that will occupy the empty spaces between the pin and the walls of the canal. Thereafter, it is performed a partial cure of the resin, removal of the canal assembly and final cure. As a result, a pin is formed conforming to the canal structures. U.S. Pat. No. 5,326,263 differs from the present invention in that it does not contain elements that cause expansion of the pin in its side parts to promote mechanical overlapping thereof and, hence, its greater retentivity.

Thus, as can be seen, none of the above-mentioned documents proposes a fastening element for insertion in the tooth canal comprising a body of parallel or conical shape; a parallel or tapered longitudinal through hole; a main longitudinal slit running through the entire length of the securing member; partial longitudinal slits in the lower and/or upper part of the body of the fastening element, the fastening element being fitted through its bore in a prefabricated pin, and wherein the fastening element will fill the void spaces of the canal left by the pin, thereby providing greater clamping and mechanical retention of the fastening element and pin assembly (fastening system) inserted into the canal.

In addition, the configuration of the fastening element for insertion in the tooth canal proposed in the present invention allows that said fastening element be positioned alone or together with the pin pre-installed within the tooth canal containing several internal diameters and different conicity, that is, the fastening element conforms to any size of canal mechanically juxtaposing (overlapping) to the walls of the same.

### SUMMARY OF THE INVENTION

In order to solve the above-mentioned problems, the present invention will provide significant advantages with respect to the fastening elements for introduction in the tooth canal.

It is an object of the present invention to provide a fastening element for introduction in the tooth canal comprising:
a body of parallel or conical shape;
a parallel or tapered longitudinal through bore; and
a main longitudinal slit running from the upper end to the lower end of the body of the fastening element.

Said fastening element positioned alone or with the pin serves as a tooth reinforcement with the treated canal and as anchorage for prostheses which have supported (will be supported) on the treated teeth.

The configuration of the fastening element for introduction in the tooth canal proposed in the present invention allows said fastening element to be positioned alone or together with the intra-radicular pin within the tooth canal containing several different internal diameters and conicities, i.e., the fastening element adapts to any canal size by mechanically juxtaposing the walls of the same.

Thus, after cementation, the fastening element of the present invention provides a high retention of the fastening system within the canal, minimizing detachment risks by being used as a base for anchoring prostheses.

It is a further object of the present invention to provide a fastening system for introduction in the tooth canal comprising the fastening element of the present invention and a prefabricated pin; whereby the fastening element with its through-bore is inserted into the prefabricated pin.

In addition, the present invention relates to the use of the fastening element for introduction in the tooth canal.

### BRIEF DESCRIPTION OF THE DRAWINGS

The structure and operation of the present invention together with further advantages thereof may be better understood with reference to the accompanying drawings and the following description:

FIG. 1A shows the introduction of a plastic pin in the state of the art;

FIG. 1B shows the filling of the resin canal made in the prior art;

FIG. 1C shows the filling of the top part of the canal with resin made in the prior art;

FIG. 1D shows the final shape after the sculpture with the use of drills that occurs in the prior art;

FIG. 2 shows a configuration of a prefabricated pin introduced in the tooth canal that occurs in the prior art;

FIG. 3 shows a preferred embodiment of the fastening element for introduction in the tooth canal of the present invention;

FIGS. 4.1 and 4.2 show an alternative embodiment of the fastening element for introduction in the tooth canal of the present invention.

FIG. 5.1 shows the fastening system of the present invention, wherein the tooth canal is arranged for insertion of the pin.

FIG. 5.2 shows the fastening system of the present invention, wherein the pin is positioned in the canal.

FIG. 5.3 shows the fastening system of the present invention, wherein the fastening element is adapted in the pin.

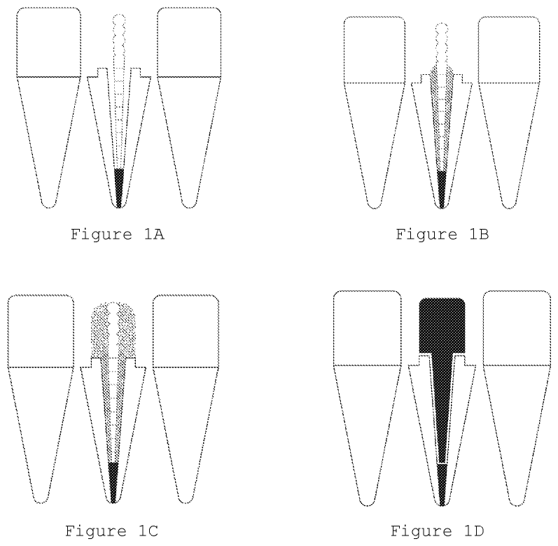

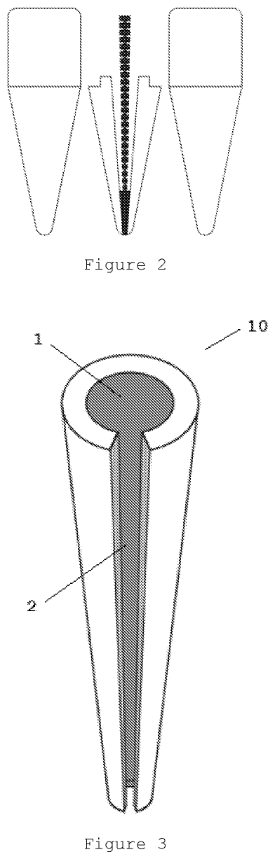

### DETAILED DESCRIPTION OF THE INVENTION

Although the present invention may be susceptible to different embodiments, it is shown in the drawings and in the following detailed discussion, a preferred embodiment and an alternate embodiment with the understanding that said embodiments are to be considered exemplifications of the principles of the invention and not limitations of the present invention.

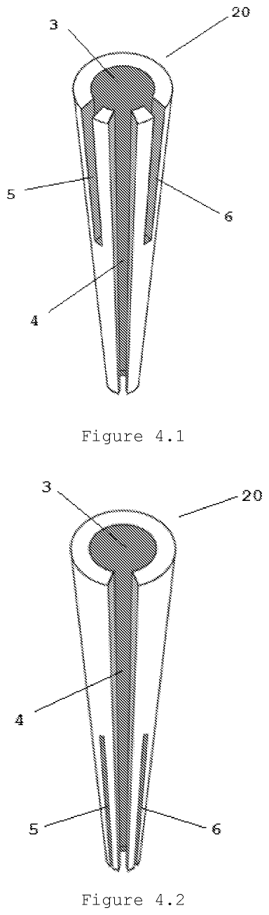

As shown by FIG. 3 of the present application, in a preferred embodiment, the present invention discloses a fastening element (10) for introduction in the tooth canal (11) comprising:
a body of parallel or conical shape;
a parallel or tapered longitudinal through bore (1);
a main longitudinal slot (2) running from the upper end to the lower end of the body of the fastening element.

In an alternative embodiment, the fastening element (20) for introduction in the tooth canal (11) of the present invention comprises:
a body of parallel or conical shape;
a parallel or tapered longitudinal through bore (3); and
a main longitudinal slot (4) extending from the upper end to the lower end of the body of the fastening element;
partial longitudinal slits (5, 6) in the lower and/or upper part,
wherein said partial longitudinal slits (5, 6) are parallel with said main longitudinal slit (3); and
wherein the partial longitudinal slits (5, 6) leave one end of the body of the securing element partially advancing its extension.

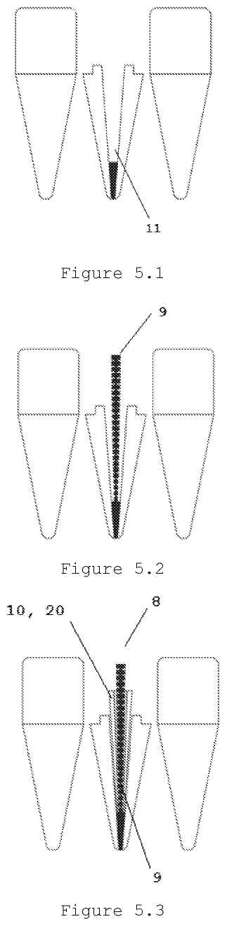

FIGS. 4.1 and 4.2 show said alternative embodiment of the fastening element (20) of the present application.

The material of the fastening element (10, 20) may be a fiber reinforced composite comprising a polymer matrix and fibers dispersed in the polymer matrix in the single or multidirectional direction.

The fibers of the reinforced composite for manufacturing the fastening element (10, 20) are fibers selected from the following group: glass, quartz, carbon, polyamide and mixtures thereof, being preferably glass fiber and quartz.

In addition, the polymer matrix of the reinforced composite for manufacturing the fastening element (10, 20) is selected from the group comprising polyamides, polyesters, polyolefins, polyimides, polyacrylates, polyurethanes, vinyl esters, epoxy-based materials, such as epoxy resin, styrene, styrene acrylonitrile, ABS polymers, polysulfones, polyacetals, polycarbonates, polyphenylene sulfides, acrylic monomers, methacrylic monomers and mixtures thereof, preferably epoxy resin.

The reinforced composite is the union of a fiber and a polymer matrix; the polymer matrix being preferably the epoxy resin.

Said reinforced composite of the fastening element (10, 20) contains radiopacifier and pigments dispersed in the polymer matrix, one or more elements of the group comprising silica, calcium phosphate, barium sulfate, alumina, zirconia, tin oxide, oxide of tantalum, niobium oxide, titanium oxide, poly (methacrylate) and mixtures thereof.

The fastening element (10, 20) for introduction in the tooth canal of the present invention has a flexural strength in the range of 300 to 1200 Mpa.

The fastening element (10, 20) according to the present invention will be fixed tangentially to the inner wall of the root canal (11) by means of chemical cements used in odontology.

Further, the body of the fastening element (10, 20) is rigid or flexible.

In addition, the present invention describes a fastening system (8) for introduction into the tooth canal (11) comprising the fastening element (10, 20) defined in the present invention and a prefabricated pin (9), and the fastening element (10, 20) with its through bore (1,3) is inserted into the prefabricated pin (9).

FIGS. 5.1, 5.2 and 5.3 show the fastening system of the present invention.

Further, the present invention describes the use of the fastening element (10, 20) defined in the present invention, wherein said fastening element (10, 20) is to be introduced in the root canal (11) of the tooth, the fastening element (10, 20) being used alone or together with a prefabricated pin (9) for strengthening the root and/or anchoring of prostheses to be installed on the tooth.

Thus, although only some embodiments of the present invention have been shown, it will be understood that various omissions, substitutions and changes in the fastening element for insertion into the tooth canal may be made by a person skilled in the art without departing from the spirit and scope of the present invention.

It is expressly provided that all combinations of the elements performing the same function in substantially the same manner to achieve the same results are within the scope of the invention. Substitutions of elements from one embodiment to another are also fully intended and contemplated.

It is also necessary to understand that the drawings are not necessarily in scale, but that they are only of a conceptual nature. The intention is therefore to be limited, as indicated by the scope of the appended claims.

1. A fastening element (10) for introduction in the tooth canal (11), characterized in that it comprises:
a body of parallel or conical shape;
a parallel or tapered longitudinal through bore (1); and
a main longitudinal slot (2) running from the upper end to the lower end of the body of the fastening element.

2. The fastening element (10) according to claim 1, characterized in that the material of the fastening element (10) is a fiber-reinforced composite comprising a polymer matrix and fibers dispersed in the polymer matrix in the single direction or multidirectional.

3. The fastening element (10) according to claim 2, characterized in that said reinforced composite comprises radiopacifier and pigments dispersed in the polymer matrix, the radio-opacifier and the pigments being selected from the group comprising: silica, phosphate calcium oxide, barium sulfate, alumina, zirconia, tin oxide, tantalum oxide, niobium oxide, titanium oxide, poly (methacrylate) and mixtures thereof.

4. The fastening element (10) according to claim 2, characterized in that said polymer matrix of the reinforced composite is selected from the group comprising polyamides, polyesters, polyolefins, polyimides, polyacrylates, polyurethanes, vinyl esters, materials based polymers, such as epoxy, styrene, styrene, acrylonitrile, ABS polymers, polysulfones, polyacetals, polycarbonates, polyphenylene sulfides, acrylic monomers, methacrylic monomers and mixtures thereof.

5. The fastening element (10) according to claim 4, characterized in that said polymer matrix is preferably epoxy resin.

6. The fastening element (10) according to claim 2, characterized in that the fibers of the reinforced composite are fibers selected from the group comprising glass, quartz, carbon, polyamide and mixtures thereof.

7. The fastening element (10) according to claim 6, characterized in that said fiber is preferably glass fiber or quartz.

8. The fastening element (10) according to claim 1, characterized in that it comprises a flexural strength in the range of 300 to 1200 MPa.

9. The fastening element (10) according to claim 1, characterized in that the fastening element (10) is fixed tangentially to the inner wall of the root canal (11) by means of chemical cements.

10. A fastening element (20) for introduction in the tooth canal (11), characterized in that it comprises:
a body of parallel or conical shape;
a parallel or tapered longitudinal through hole (3);
a main longitudinal slit (4); and
partial longitudinal slots (5, 6) in the upper and/or lower part of the body of the fastening element,
wherein said partial longitudinal slits (5, 6) are parallel with said main longitudinal slit (4); and
wherein the partial longitudinal slots (5, 6) leave one end of the body of the fastening element partially advancing its extension.

11. The fastening element (20) according to claim 10, characterized in that the material of the fastening element is a fiber reinforced composite comprising a polymer matrix and fibers dispersed in the polymer matrix in the single or multidirectional direction.

12. The fastening element (20) according to claim 11, characterized in that said reinforced composite comprises radiopacifier and pigments dispersed in the polymer matrix, the radiopacifier and the pigments being selected from the group comprising: silica, phosphate calcium oxide, barium sulfate, alumina, zirconia, tin oxide, tantalum oxide, niobium oxide, titanium oxide, poly (methacrylate) and mixtures thereof.

13. The fastening element (20) according to claim 11, characterized in that said polymer matrix of the reinforced composite is selected from the group comprising polyamides, polyesters, polyolefins, polyimides, polyacrylates , polyurethanes, vinyl esters, materials based polymers such as epoxy, styrene, acrylonitrile, ABS polymers, polysulfones, polyacetals, polycarbonates, polyphenylene sulfides, acrylic monomers, methacrylic monomers and mixtures thereof.

14. The fastening element (20) according to claim 13, characterized in that said polymeric matrix is preferably epoxy resin.

15. The fastening element (20) according to claim 11, characterized in that the fibers of the reinforced composite are fibers selected from the group comprising glass, quartz, carbon, polyamide and mixtures thereof.

16. The fastening element (20) according to claim 15, characterized in that said fiber is preferably glass fiber or quartz.

17. The fastening element (20) according to claim 11, characterized in that it comprises a flexural strength in the range of 300 to 1200 Mpa,

18. The fastening element (20) according to claim 10, characterized in that the fastening element is fixed tangentially to the inner wall of the root canal (11) by means of chemical cements.

19. A fastening system for introduction in the tooth canal (8), characterized in that it comprises the fastening element (10, 20) and a prefabricated pin (9); in which the fastening element (10, 20) with its through bore (1, 3) is inserted in the prefabricated pin (9).

20. A method comprising introducing a fastening system (10, 20) into a tooth canal (11).

21. The method according to claim 20, characterized in that said fastening element (10, 20) is used alone or together with a prefabricated pin (9) for root reinforcement and supporting for prostheses to be installed on the tooth.
